(19) United States
(12) Patent Application Publication
(10) Pub. No.: US 2025/0125497 A1
(43) Pub. Date: Apr. 17, 2025

(54) BATTERY MODULE

(71) Applicant: TOYOTA JIDOSHA KABUSHIKI KAISHA, Toyota-shi (JP)

(72) Inventors: Shinya ISHIKAWA, Anjo-shi (JP); Takashi MIURA, Nagoya-shi (JP); Tetsuya MIMURA, Chiryu-shi (JP); Toshihiro SHIMONAKA, Toyota-shi (JP); Yuki HIRATA, Chigasaki-shi (JP); Masayoshi HAGA, Nagoya-shi (JP); Kazuya KUMAZAWA, Nagoya-shi (JP)

(21) Appl. No.: 18/907,604

(22) Filed: Oct. 7, 2024

(30) Foreign Application Priority Data
Oct. 17, 2023 (JP) 2023-179066

(51) Int. Cl. H01M 50/51; B60L 50/64; H01M 50/211; H01M 50/507

(52) U.S. Cl. CPC H01M 50/51; H01M 50/211; H01M 50/507; B60L 50/64; H01M 2220/20

(57) ABSTRACT

A battery module in which a laminated body configured by laminating plural battery cells to each other is accommodated within a module case and in which plural battery cells are electrically connected to each other, wherein: the each battery cell includes a first electrode lead that protrudes at one side in a width direction along a first side surface portion at one side in the thickness direction, and a second electrode lead that protrudes at another side in the width direction along a second side surface portion at another side in the thickness direction; and each battery cell has a symmetrical structure in which height positions of the first electrode lead and the second electrode lead do not change in an inverted posture inverted along a center line in the thickness direction and an inverted posture inverted along a center line in the width direction.

### CROSS-REFERENCE TO RELATED APPLICATION

This application is based on and claims priority under 35 USC 119 from Japanese Patent Application No. 2023-179066, filed on Oct. 17, 2023, the entire disclosure of which is incorporated by reference herein.

### BACKGROUND

### Technical Field

The present disclosure relates to a battery module.

### Related Art

Japanese Patent Application Laid-Open (JP-A) No. 2009-016122 describes a laminate-type secondary battery in which a battery element having a substantially rectangular planar shape in which a positive electrode and a negative electrode are laminated via a separator is encased with a laminate material, and in which a positive electrode tab and a negative electrode tab are formed so as to be drawn out from opposite sides.

In this laminate-type secondary battery, the positive electrode tab and the negative electrode tab are arranged outside of a center line at the respective sides at which they are drawn out. As a result, in a case in which a plurality of batteries are configured in a laminated state, upper and lower tabs that are to be electrically connected are arranged in the same direction with respect to the center line to facilitate connection, and upper and lower tabs that are not to be electrically connected are arranged in different directions with respect to the center line, whereby contact is avoided.

However, in a module having a structure in which a plurality of secondary batteries (battery cells) are connected to each other via a bus bar, if a configuration is provided in which the electrode tabs are connected to each other at a plurality of positions within a module case in consideration of close arrangement and spaced arrangement of adjacent electrode tabs as described in aforementioned Japanese Patent Application Laid-Open (JP-A) No. 2009-016122, there is a possibility that an arrangement of the bus bar will become complicated or a size of the bus bar will be increased, thereby reducing spatial efficiency within the module case.

### SUMMARY

In view of the aforementioned circumstances, it is an object of the present disclosure to provide a battery module that is capable of optimizing an arrangement of a bus bar and increasing spatial efficiency within a module case.

A battery module of a first aspect is a battery module in which a laminated body configured by laminating plural battery cells to each other is accommodated within a module case and in which plural battery cells are electrically connected to each other via a bus bar, wherein: the battery cells are accommodated in a posture in which a lamination direction thereof is along a thickness direction thereof; each battery cell includes a first electrode lead that protrudes at one side in a width direction of the battery cell along a first side surface portion at one side in the thickness direction, and a second electrode lead that protrudes at another side in the width direction along a second side surface portion at another side in the thickness direction; and each battery cell has a symmetrical structure in which height positions of the first electrode lead and the second electrode lead do not change in an inverted posture inverted along a center line in the thickness direction and an inverted posture inverted along a center line in the width direction.

In the battery module of the first aspect, the laminated body configured by laminating the plural battery cells to each other is accommodated within the module case. Further, plural battery cells are electrically connected to each other via the bus bar. The battery cells are accommodated in a posture in which the lamination direction thereof is along the thickness direction thereof, and each include the first electrode lead that protrudes at one side in the width direction along the first side surface portion at one side in the thickness direction, and the second electrode lead that protrudes at another side in the width direction along the second side surface portion at another side in the thickness direction. In other words, in each battery cell, the first electrode lead and the second electrode lead are set at different positions in the lamination direction.

In this regard, each battery cell has a symmetrical structure in which the height positions of the first electrode lead and the second electrode lead do not change in an inverted posture inverted along the center line in the thickness direction and an inverted posture inverted along the center line in the width direction. For this reason, by housing a portion of the battery cells within the module case in a posture that is inverted along the center line in the thickness direction or the center line in the width direction, it is possible to realize a close arrangement of electrode leads having the same electrical polarity, close arrangement of electrode leads having different electrical polarities, and the like, at the same height positions within the module case. As a result, the arrangement of the bus bar can be optimized, and spatial efficiency within the module case can be increased.

A battery module of a second aspect is the battery module of the first aspect, wherein, due to one of two battery cells that are adjacent in the lamination direction being put in an inverted posture inverted along the center line in the thickness direction, the laminated body includes at least one first laminated portion at which a first electrode lead and a second electrode lead are arranged close to each other at one side in the width direction.

In the battery module of the second aspect, the laminated body includes at least one first laminated portion. In the first laminated portion, due to one of the two battery cells that are adjacent in the lamination direction being put in an inverted posture inverted along the center line in the thickness direction, the first electrode lead and the second electrode lead are arranged close to each other at one side in the width direction. As a result, electrode leads having different electrical polarities can be arranged close to each other, and series connection between two battery cells can easily and efficiently be performed via the bus bar.

A battery module of a third aspect is the battery module of the first aspect, wherein, due to one of two battery cells that are adjacent in the lamination direction being put in an inverted posture inverted along the center line in the width direction, the laminated body includes at least one second laminated portion at which first electrode leads or second electrode leads are arranged close to each other at one side in the width direction.

In the battery module of the third aspect, the laminated body includes at least one second laminated portion. In the second laminated portion, due to one of the two battery cells that are adjacent in the lamination direction being put in an inverted posture inverted along the center line in the width direction, the first electrode lead and the second electrode lead are arranged close to each other at one side in the width direction. As a result, electrode leads having the same electrical polarity can be arranged close to each other, and parallel connection between two battery cells can easily and efficiently be performed via the bus bar.

A battery module of a fourth aspect is the battery module of the second aspect, wherein: the laminated body incudes plural third laminated portions that are each configured by laminating two battery cells that are adjacent in the lamination direction in a same posture; due to one of two third laminated portions that are adjacent in the lamination direction being put in an inverted posture inverted along the center line in the thickness direction, a first laminated portion is formed by two adjacent battery cells between the two third laminated portions; and the bus bar includes, at one side of the laminated body in the width direction, at least one series connection portion at which a first electrode lead and a second electrode lead that are close to each other in the first laminated portion are electrically connected in series.

In the battery module of the fourth aspect, the laminated body includes plural third laminated portions that are each configured by laminating two battery cells that are adjacent in the lamination direction in the same posture. Further, in the laminated body, when two third laminated portions that are adjacent in the lamination direction are electrically connected in series, by putting one of the two third laminated portions in an inverted posture inverted along the center line in the thickness direction, a first laminated portion is formed by two adjacent battery cells between the two third laminated portions. For this reason, at one side of the laminated body in the width direction, a series connection portion is formed at the bus bar, in which a first electrode lead and a second electrode lead, which are close to each other in the first laminated portion, are electrically connected in series. As a result, when electrically connecting, in series, laminated portions configured by two battery cells that are connected in parallel, plural electrode leads can be efficiently arranged at one side of the laminated body in the width direction, and as a result, series connection between the laminated portions configured by the two battery cells that are connected in parallel can easily and efficiently be performed via the bus bar.

As described above, in the battery module according to the present disclosure, an arrangement of a bus bar can be optimized, and spatial efficiency within a module case can be increased.

### BRIEF DESCRIPTION OF THE DRAWINGS

Exemplary embodiments of the present invention will be described in detail based on the following figures, wherein:

FIG. 1 is a schematic plan view illustrating a main portion of a vehicle to which a battery pack according to an exemplary embodiment is applied;

FIG. 2 is a schematic perspective view of a battery module according an exemplary embodiment;

FIG. 3 is a plan view of a battery module according to an exemplary embodiment in a state in which an upper lid of a module case has been removed;

FIG. 4 is a schematic view of a battery cell accommodated in a battery module, as viewed from a thickness direction;

FIG. 5 is a schematic view of a battery cell accommodated in a battery module, as viewed from a height direction;

FIG. 6A is a schematic view of a first laminated portion of a laminated body according to an exemplary embodiment, as viewed from a height direction;

FIG. 6B is a schematic view of a second laminated portion of a laminated body according to an exemplary embodiment, as viewed from a height direction; and

FIG. 6C is a schematic view of third laminated portions of a laminated body according an exemplary embodiment and a series connection portion at which two adjacent third connection portions are electrically connected in series, as viewed from a height direction.

### DETAILED DESCRIPTION

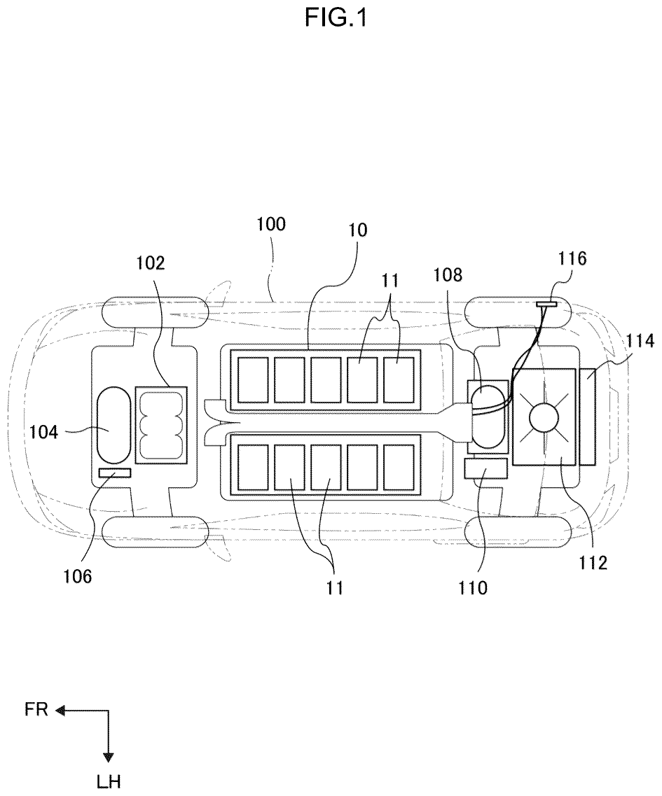

An embodiment of the present disclosure will be explained below with reference to FIG. 1 to FIG. 6C.

### (Overall Configuration of Vehicle 100)

FIG. 1 is a schematic plan view illustrating a main portion of a vehicle 100 to which a battery pack 10 according to an exemplary embodiment is applied. As shown in FIG. 1, the vehicle 100 is an electric vehicle (battery electric vehicle (BEV)) in which a battery pack 10 is mounted under a floor. It should be noted that arrow UP, arrow FR, and arrow LH in the respective drawings respectively indicate an upper side in a vehicle up-down direction, a front side in a vehicle front-rear direction, and a left side in a vehicle width direction. In cases in which explanation is given using front-rear, left-right, and up-down directions, unless otherwise specified, these indicate front and rear in the vehicle front rear direction, left and right in the vehicle width direction, and up and down in the vehicle up-down direction.

As an example, in the vehicle 100 of the present exemplary embodiment, a DC/DC converter 102, an electric compressor 104, and a positive temperature coefficient (PTC) heater 106 are arranged further toward a vehicle front side than the battery pack 10. Further, a motor 108, a gear box 110, an inverter 112, and a charger 114 are arranged further toward a vehicle rear side than the battery pack 10.

A DC current that has been output from the battery pack 10 is adjusted in voltage by the DC/DC converter 102, and thereafter supplied to the electric compressor 104, the PTC heater 106, the inverter 112, and the like. Furthermore, due to electric power being supplied to the motor 108 via the inverter 112, rear wheels rotate to drive the vehicle 100.

A charging port 116 is provided at a right side portion of a rear portion of the vehicle 100, and by connecting a charging plug of an external charging facility, which is not illustrated in the drawings, from the charging port 116, electric power can be stored in the battery pack 10 via the vehicle-mounted charger 114.

It should be noted that an arrangement, structure and the like of the respective components configuring the vehicle 100 are not limited to the configuration described above. For example, the present disclosure may be applied to a hybrid vehicle (HV) or a plug-in hybrid vehicle (plug-in hybrid electric vehicle (PHEV)) at which an engine is mounted. Further, in the present exemplary embodiment, although the vehicle is configured as a rear-wheel drive vehicle in which the motor 108 is mounted at the rear portion of the vehicle, there is no limitation thereto; the vehicle may be configured as a front-wheel drive vehicle in which the motor 108 is mounted at the front portion of the vehicle, and a pair of motors 108 may also be mounted at the front and rear of the vehicle. Furthermore, the vehicle may also be provided with in-wheels motors at the respective wheels.

The battery pack 10 is configured to include plural battery modules 11. In the present exemplary embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Furthermore, each of the battery modules 11 are electrically connected to each other.

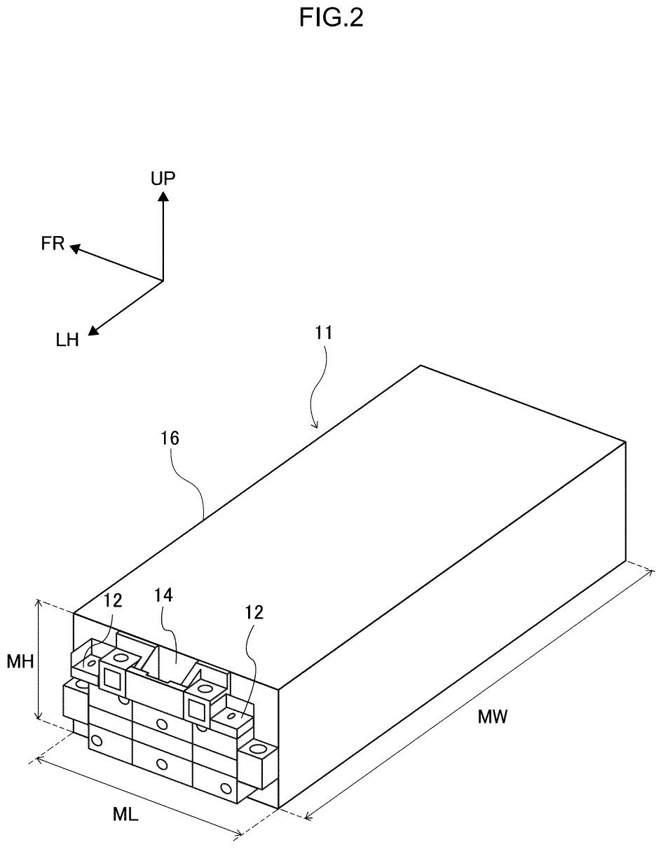

FIG. 2 is a schematic perspective view of the battery module 11. As shown in FIG. 2, the battery module 11 includes a module case 16 forming an outer shell. The module case 16 is formed in a substantially rectangular parallelepiped shape having a longitudinal direction along the vehicle width direction. Furthermore, the module case 16 is formed of an aluminum alloy. For example, the module case 16 is formed by joining aluminum die-casting to both end portions of an extruded material of an aluminum alloy by laser welding or the like.

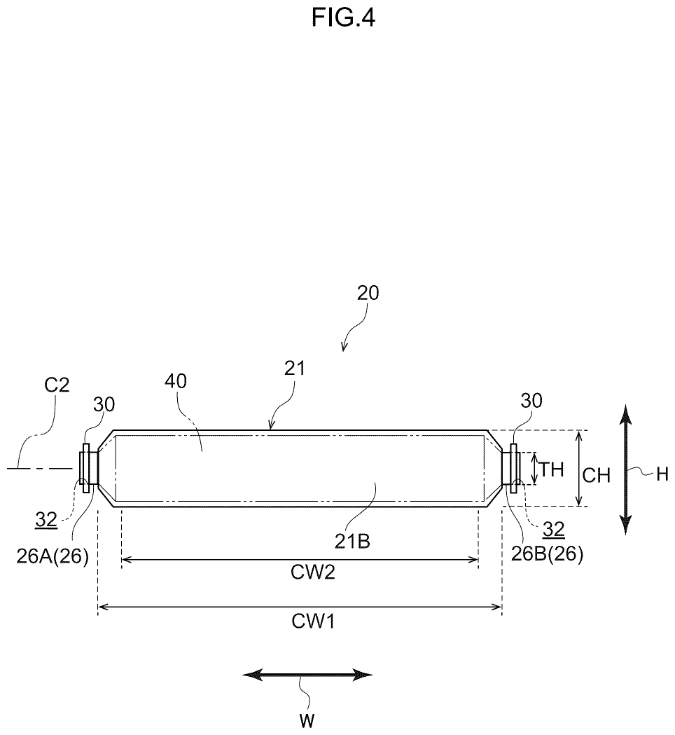

A pair of voltage terminals 12 and a connector 14 are provided at both vehicle width direction end portions of the battery module 11. A flexible printed circuit board 21, which will be described later, is connected to the connector 14. Furthermore, bus bars 30 (refer to FIG. 4) are welded to both vehicle width direction end portions of the battery module 11.

A length MW of the battery module 11 in the vehicle width direction is, for example, from 350 mm to 600 mm, a length ML thereof in the vehicle front-rear direction is, for example, from 150 mm to 250 mm, and a height MH thereof in the vehicle up-down direction is, for example, from 80 mm to 110 mm.

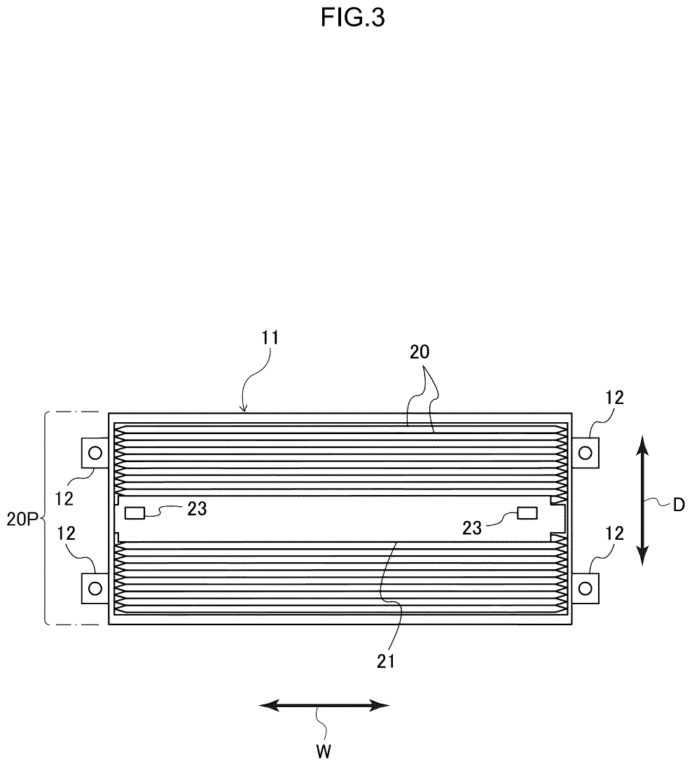

FIG. 3 is a plan view of the battery module 11 in a state in which an upper lid has been removed. As shown in FIG. 3, a laminated body 20P configured by laminating plural battery cells 20 to each other is accommodated at an interior of the module case 16. The respective battery cells 20 are accommodated in a posture in which a lamination direction is a thickness direction. In the present exemplary embodiment, 24 battery cells 20 are arranged (laminated) in the vehicle front-rear direction and adhered to each other to thereby configure the laminated body 20P.

It should be noted that, for ease of explanation, in each of FIGS. 3 to 5, a direction indicated by arrow W is defined as a width direction of the battery cells 20, a direction indicated by arrow H is defined as a height direction (up-down direction) of the battery cells 20, and a direction indicated by arrow D is defined as a thickness direction of the battery cells 20.

A width direction of a battery case 22, which will be described later, corresponds to the width direction W of the battery cells 20. A height direction of the battery case 22 corresponds to the height direction H of the battery cells 20. A thickness direction of the battery case 22 corresponds to the thickness direction D of the battery cells 20.

A flexible printed circuit (FPC) board 21 is arranged on the battery cells 20. The flexible printed circuit board 21 is formed in a band shape with a longitudinal direction thereof along the vehicle width direction, and thermistors 23 are respectively provided at both end portions of the flexible printed circuit board 21. The thermistors 23 are not adhered to the battery cells 20 and are configured to be pressed toward the battery cells 20 side by the upper lid of the battery module 11.

Furthermore, one or more cushioning materials, which are not illustrated in the drawings, are accommodated at the interior of the module case 16. For example, the cushioning material is a thin plate-shaped member that is elastically deformable, and is arranged between adjacent battery cells 20 with a thickness direction thereof along an arrangement direction of the battery cells 20. In the present exemplary embodiment, as an example, cushioning materials are respectively arranged at both longitudinal direction end portions of the module case 16 and at a longitudinal direction central portion thereof.

FIG. 4 is a schematic view of a battery cell 20 that is accommodated in the battery module 11, as viewed from the thickness direction D. As shown in FIG. 4, the battery cell 20 is formed in an elongated rectangular plate shape having a longitudinal direction thereof along the width direction W, and has an exterior material 21 forming an outer shell and an electrode body 40 that is accommodated at an interior of the exterior material 21.

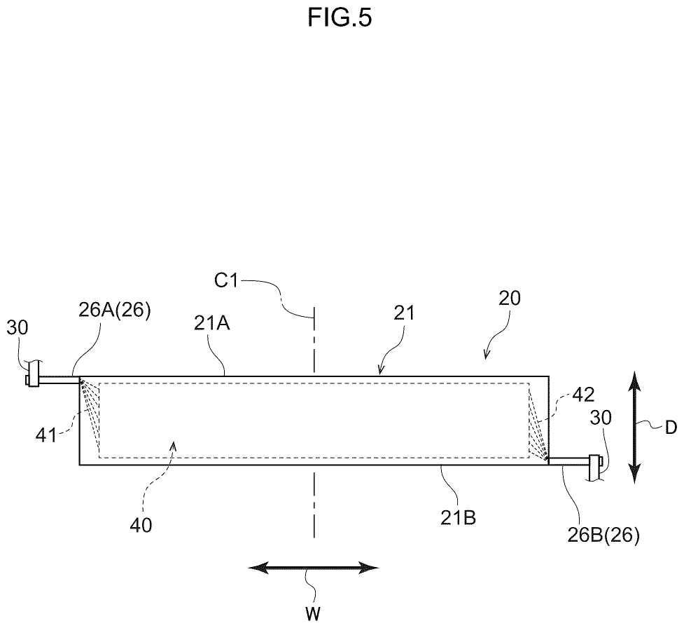

FIG. 5 is a schematic view of a battery cell 20 that is accommodated in the battery module 11, as viewed from the height direction H. As shown in FIG. 5, the exterior material 21 has a first side surface portion 21A that configures one side surface of the battery cell 20 in the thickness direction D, and a second side surface portion 21B that configures another side surface in the thickness direction D.

Various exterior materials can be used as the exterior material 21. For example, the exterior material 21 may be configured by a laminate film, a flat box-shaped case, or the like. Furthermore, the exterior material 21 may be configured by a coating material that is coated directly on the electrode body 40 or via a coated material such as a film or the like. In the present exemplary embodiment, the battery case 22 is configured by adhesion of plural laminate films, and the electrode body 40 is sealed by the laminate films.

The electrode body 40 is configured by laminating a positive electrode serving as an electrode, a negative electrode serving as an electrode, and a separator. The positive electrode and the negative electrode of the electrode body 40 are configured by a metal foil or the like, and at one side of the electrode body 40 in the width direction W, end portions of plural laminated positive electrode sheets are gathered to configure a positive electrode current collector 41, which is connected to an electrode lead 26 (26A), which will be described later (refer to FIG. 5). Furthermore, at another side of the electrode body 40 in the width direction W, end portions of plural laminated negative electrode sheets are gathered to configure a negative electrode current collector 42, which is connected to an electrode lead 26 (26B) (refer to FIG. 5).

The electrode lead 26 is provided so as to protrude from both end portions of the battery cell 20 (the exterior material 21) in the width direction W. The electrode lead 26 is formed in a thin plate shape, and one end thereof that is arranged at the interior of the battery case 22 is connected to the electrode body 40. The electrode lead 26 is configured by a first electrode lead 26A that is connected to the positive electrode current collector 41 of the electrode body 40, and a second electrode lead 26B that is connected to the negative electrode current collector 42 of the electrode body 40. The first electrode lead 26A protrudes at one side in the width direction W along the first side surface portion 21A at the one side of the battery cell 20 in the thickness direction D. The second electrode lead 26B protrudes at the other side in the width direction W along the second side surface portion 21B at the other side in the thickness direction D. For this reason, in the battery cell 20, positions of the first electrode lead 26A and the second electrode lead 26B are arranged at different positions in the thickness direction D (lamination direction) in a plan view as viewed from the height direction H.

Further, each of the first electrode lead 26A and the second electrode lead 26B protrude from a central position of the battery cell 20 in the height direction H (refer to FIG. 4). For this reason, the battery cell 20 has a symmetrical structure in which height positions of the first electrode lead 26A and the second electrode lead 26B do not change in an inverted posture inverted along a center line C1 in the thickness direction D (refer to FIG. 5) and an inverted posture inverted along a center line C2 in the width direction W.

The electrode lead 26 of each battery cell is welded to a bus bar 30, which will be described later, to thereby electrically couple the battery cells 20 to each other via the bus bar 30. Furthermore, the electrode leads 26 are connected to a wiring at an exterior of the battery module 11 via the bus bar 30. Although a known welding method can be appropriately adopted for the welding of the electrode lead 26 and the bus bar 30, in the present exemplary embodiment, the electrode lead 26 and the bus bar 30 are coupled by laser welding.

A length CW1 of the battery cell 20 in the vehicle width direction is, for example, from 530 mm to 600 mm, from 600 mm to 700 mm, from 700 mm to 800 mm, from 800 mm to 900 mm, or 1000 mm or more, a length CW2 of a region in which the electrode body is accommodated is, for example, from 500 mm to 520 mm, from 600 mm to 700 mm, from 700 mm to 800 mm, from 800 to 900 mm, or 1000 mm or more, and a height CH of the battery cell 20 is, for example, from 80 mm to 110 mm, or from 110 mm to 140 mm. Furthermore, a thickness of the battery cell 20 is from 5.0 mm to 7.0 mm, from 7.0 mm to 9.0 mm, or from 9.0 mm to 11.0 mm, and a height TH of the electrode lead (terminal) 26 is from 40 mm to 50 mm, from 50 mm to 60 mm, or from 60 mm to 70 mm.

The bus bar 30 is formed in a plate shape with a plate thickness direction being the width direction W of the battery cells 20, and extends along the lamination direction (thickness direction D) of the battery cells 20. Within the module case 16, a plurality of bus bars 30 are respectively arranged on one side and another side of the battery cells 20 in the width direction W. As an example, the electrode lead 26 is inserted into a slot-shaped through-hole 32 that penetrates the bus bar 30 in the plate thickness direction, and is welded to a surface of the bus bar 30 in a state in which an end portion protruding from the through-hole 32 is folded back toward a bus bar 30 side. As a result, welding can be performed by an operation from an outer side of the battery cell 20 in the width direction W, and execution thereof can be facilitated.

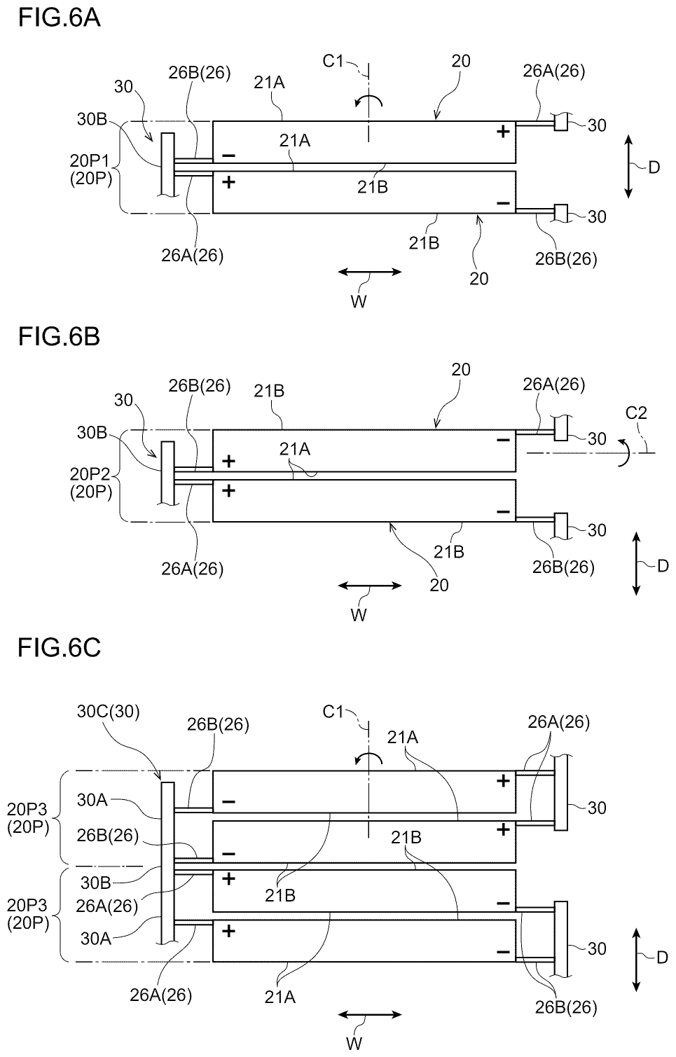

The bus bar 30 is provided with a first connection portion 30A (refer to FIG. 6B) that electrically connects adjacent battery cells to each other in parallel, and a second connection portion 30B (refer to FIG. 6A) that electrically connects two first connection portions 30A in series.

### (Lamination Method of Battery Cells)

As described above, the battery cell 20 has a symmetrical structure in which height positions of the first electrode lead 26A and the second electrode lead 26B do not change in the inverted posture inverted along the center line C1 in the thickness direction D (refer to FIG. 5) and the inverted posture inverted along the center line C2 in the width direction W. Due to such a symmetrical structure of the battery cell 20, in the battery module 11, by accommodating a portion of the battery cells 20 within the module case 16 in an inverted posture along the center line C1 in the thickness direction D or the center line C2 in the width direction W, it is possible to realize a close arrangement of electrode leads 26 having the same electrical polarity, close arrangement of electrode leads 26 having different electrical polarities, and the like, at the same height positions within the module case 16.

An example of a lamination method of the battery cells 20 will be explained with reference to FIG. 6A to FIG. 6C. FIG. 6A to FIG. 6C are schematic views illustrating a first laminated portion 20P1, a second laminated portion 20P2, and a third laminated portion 20P3, which may constitute a portion or all of the laminated body 20P, assuming that the laminated body 20P within the module case 16 is viewed from an upper side.

It should be noted that, for convenience of explanation, in FIG. 6A to FIG. 6C, a state in which a space is provided between adjacent battery cells 20 is illustrated, but in actuality, the plural laminated battery cells 20 are in contact with each other via the cushioning material or directly, and are restrained by each other in a state in which a predetermined restraining pressure is applied along the lamination direction (thickness direction D).

FIG. 6A illustrates the first laminated portion 20P1, which can configure a portion or all of the laminated body 20P. The first laminated portion 20P1 is formed by laminating one of two battery cells 20 that are adjacent to each other in the lamination direction in an inverted posture inverted along the center line C1 in the thickness direction D. In the first laminated portion 20P1, by inverting one battery cell 20, the first electrode lead 26A and the second electrode lead 26B are arranged close to each other at one side in the width direction W. In other words, at one side of the first laminated portion 20P1 in the width direction W, electrode leads 26 having different electrical polarities can be drawn out toward a bus bar 30 side in a state in which they are arranged close to each other. In the example shown in the FIG. 6A, the adjacent battery cells 20 are connected to each other in series via the second connection portion 30B of the bus bar 30.

FIG. 6B illustrates the second laminated portion 20P2, which can configure a portion or all of the laminated body 20P. The second laminated portion 20P2 is laminated in an inverted posture in which one of two battery cells 20 that are adjacent in the lamination direction is inverted along the center line C2 in the width direction W. In the second laminated portion 20P2, at one side in the width direction W, first electrode leads 26A (or second electrode leads 26B) having the same electrical polarity can be drawn out toward the bus bar 30 side in a state in which they are arranged close to each other. In the example shown in FIG. 6B, the adjacent battery cells 20 are connected to each other in parallel via the first connection portion 30A of the bus bar 30.

FIG. 6C illustrates the third laminated portion 20P3, which can configure a portion or all of the laminated body 20P. In the third laminated portion 20P3, two battery cells that are adjacent to each other in the lamination direction are laminated in the same posture. In the third laminated portion 20P3, at one side and another side in the width direction W, first electrode leads 26A and second electrode leads 26B, which have the same electrical polarity, are arranged to be spaced apart from each other by a thickness of the battery cell 20.

Further, in the example shown in the FIG. 6C, two third laminated portions 20P3 are adjacent in the lamination direction, and one of the two third laminated portions 20P3 is laminated in an inverted posture inverted along the center line C1 in the thickness direction D. Consequently, between the two third laminated portions 20P3, a first laminated portion 20P1 is formed by two adjacent battery cells 20. In other words, at one side of the laminated body 20P in the width direction W, a first electrode lead 26A of a battery cell 20 configuring one of the two third laminated portions 20P3 and a second electrode lead 26B of a battery cell 20 configuring another of the two third laminated portions 20P3 can be drawn out toward the bus bar 30 side in a state in which they are arranged close to each other.

At the bus bar 30, the two battery cells 20 configuring the third laminated portion 20P3 are connected in parallel via the first connection portion 30A. Furthermore, at the bus bar 30, the two third laminated portions 20P3 are connected in series via the second connection portion 30B. As a result, at the bus bar 30, a series connection portion 30C is formed, which electrically connects in series between laminated portions configured by two battery cells 20 that are connected in parallel.

### Operation and Effects

As explained above, in the battery module 11 according to the present exemplary embodiment, the laminated body 20P configured by laminating plural battery cells 20 to each other is accommodated within the module case 16. Further, the plural battery cells 20 are electrically connected to each other via a bus bar 30. Each battery cell 20 is accommodated in a posture with the lamination direction along the thickness direction D and has the first electrode lead 26A that protrudes at one side in the width direction W along the first side surface portion 21A at on side in the thickness direction D. Furthermore, each battery cell 20 has the second electrode lead 26B that protrudes at the other side in the width direction W along the second side surface portion 21B at the other side in the thickness direction D. In other words, in each battery cell 20, the first electrode lead 26A and the second electrode lead 26B are set at different positions in the lamination direction.

In this regard, the battery cell 20 has a symmetrical structure in which the height positions of the first electrode lead 26A and the second electrode lead 26B do not change in an inverted posture inverted along the center line C1 in the thickness direction D and an inverted posture inverted along the center line C2 in the width direction W. For this reason, by accommodating a portion of the battery cells 20 within the module case 16 in postures that are inverted along the center line C1 in the thickness direction D or the center line C2 in the width direction W, it is possible to realize close arrangement of electrode leads 26 having the same electrical polarity and close arrangement of electrode leads 26 having different electrical polarities at the same height position within the module case 16. As a result, arrangement of the bus bar 30 can be optimized, and spatial efficiency within the module case 16 can be increased.

Further, as shown in FIG. 6A, a portion or all of the laminated body 20P according to the present exemplary embodiment may be configured by the first laminated portion 20P1. In the first laminated portion 20P1, by putting one of two battery cells 20 that are adjacent in the lamination direction into an inverted posture inverted along the center line C1 in the thickness direction D, a first electrode lead 26A and a second electrode lead 26B are arranged close to each other in the width direction W. As a result, electrode leads 26 having different electrical polarities can be arranged close to each other, and series connection between the two battery cells 20 can easily and efficiently be performed via the bus bar 30.

Furthermore, as shown in FIG. 6B, a portion or all of the laminated body 20P according to the present exemplary embodiment may be configured by the second laminated portion 20P2. In the second laminated portion 20P2, by putting one of two battery cells 20 that are adjacent in the lamination direction into an inverted posture inverted along the center line C2 in the width direction W, a first electrode lead 26A and a second electrode lead 26B are arranged close to each other in the width direction W. As a result, electrode leads 26 having the same electrical polarity can be arranged close to each other, and parallel connection between the two battery cells 20 can easily and efficiently be performed via the bus bar 30.

Furthermore, as shown in FIG. 6C, a portion or all of the laminated body 20P according to the present exemplary embodiment may be configured by the third laminated portion 20P3. In the third laminated portion 20P3, by laminating two battery cells 20 that are adjacent in the lamination direction in the same posture, electrode leads 26 having the same electrical polarity can be arranged spaced apart from each other at one side and the other side in the width direction W.

Moreover, in the laminated body 20P, when two third laminated portions 20P3 that are adjacent in the lamination direction are electrically connected in series, by putting one of the two third laminated portions 20P3 into an inverted posture inverted along the center line C1 in the thickness direction D, a first laminated portion 20P1 is formed by two adjacent battery cells 20 between the two third laminated portions 20P3. For this reason, at one side of the laminated body 20P in the width direction W, a series connection portion 30C is formed at the bus bar 30, in which a first electrode lead 26A and a second electrode lead 26B, which are close to each other in the first laminated portion 20P1, are electrically connected in series. As a result, when electrically connecting, in series, laminated portions configured by two battery cells 20 that are connected in parallel, plural electrode leads 26 can be efficiently arranged at one side of the laminated body 20P in the width direction W, and as a result, series connection between the laminated portions configured by the two battery cells 20 that are connected in parallel can easily and efficiently be performed via the bus bar 30.

What is claimed is:

1. A battery module in which a laminated body configured by laminating a plurality of battery cells to each other is accommodated within a module case and in which a plurality of the battery cells are electrically connected to each other via a bus bar, wherein:
the battery cells are accommodated in a posture in which a lamination direction thereof is along a thickness direction thereof;
each battery cell includes:
a first electrode lead that protrudes at one side in a width direction of the battery cell along a first side surface portion at one side in the thickness direction, and
a second electrode lead that protrudes at another side in the width direction along a second side surface portion at another side in the thickness direction; and
each battery cell has a symmetrical structure in which height positions of the first electrode lead and the second electrode lead do not change in an inverted posture inverted along a center line in the thickness direction and an inverted posture inverted along a center line in the width direction.

2. The battery module according to claim 1, wherein, due to one of two battery cells that are adjacent in the lamination direction being put in an inverted posture inverted along the center line in the thickness direction, the laminated body includes at least one first laminated portion at which a first electrode lead and a second electrode lead are arranged close to each other at one side in the width direction.

3. The battery module according to claim 1, wherein, due to one of two battery cells that are adjacent in the lamination direction being put in an inverted posture inverted along the center line in the width direction, the laminated body includes at least one second laminated portion at which first electrode leads or second electrode leads are arranged close to each other at one side in the width direction.

4. The battery module according to claim 2, wherein:
the laminated body incudes a plurality of third laminated portions that are each configured by laminating two battery cells that are adjacent in the lamination direction in a same posture;
due to one of two third laminated portions that are adjacent in the lamination direction being put in an inverted posture inverted along the center line in the thickness direction, a first laminated portion is formed by two adjacent battery cells between the two third laminated portions; and
the bus bar includes, at one side of the laminated body in the width direction, at least one series connection portion at which a first electrode lead and a second electrode lead that are close to each other in the first laminated portion are electrically connected in series.
